(19) United States
(12) Patent Application Publication
(10) Pub. No.: US 2024/0338710 A1
(43) Pub. Date: Oct. 10, 2024

(54) REAL-TIME ASSISTANCE FOR A CUSTOMER AT A POINT OF DECISION THROUGH HARDWARE AND SOFTWARE SMART INDICATORS DETERMINISTICALLY GENERATED THROUGH ARTIFICIAL INTELLIGENCE

(71) Applicant: GLADLY SOFTWARE INC., SAN FRANCISCO, CA (US)

(72) Inventors: Theodore Mico, Venice, CA (US); Evan Gregory Tann, Santa Monica, CA (US); Michael Block, Los Angeles, CA (US); Zachi Cohen, Los Angeles, CA (US); Yueyang Li, San Francisco, CA (US); Gerad Suyderhoud, San Francisco, CA (US)

(21) Appl. No.: 18/627,104

(22) Filed: Apr. 4, 2024

Related U.S. Application Data
(60) Provisional application No. 63/456,808, filed on Apr. 4, 2023.

(51) Int. Cl. G06Q 30/015; G06N 5/02

(52) U.S. Cl. CPC G06Q 30/015; G06N 5/02

(57) ABSTRACT

A computer-performed method, which may be performed by a chatbot server, is for customer assistance using AI-generated smart indicators. A request for customer assistance from a user is received through a dynamic chatbot. User intent and context information is determined, based on the received request. User intent and context information is mapped, as contextual data, relative to indicators that are suitable for display in a user interface. An AI-based configurator sets up for display, at least one relevant smart indicator, based on the mapped contextual data. A user interface featuring at least one relevant smart indicator is generated for display, to provide customer assistance based on the AI-based configurator set up smart indicator(s).

This application claims benefit of priority from U.S. Provisional Application No. 63/456,808, titled “REAL-TIME ASSISTANCE FOR A CUSTOMER AT A POINT OF DECISION THROUGH HARDWARE AND SOFTWARE SMART INDICATORS DETERMINISTICALLY GENERATED THROUGH ARTIFICIAL INTELLIGENCE” and filed Apr. 4, 2023, which is hereby incorporated by reference.

### FIELD OF TECHNOLOGY

This disclosure relates generally to consumer goods and services technology, and, more particularly, to the deterministic generation of smart indicators through artificial intelligence and modeled onto physical hardware, software, and/or hybrid configurations.

### SUMMARY

Various embodiments that provide real-time assistance for a customer at a point of decision through hardware and software smart indicators deterministically generated through artificial intelligence and/or further features are described herein.

Some embodiments include a computer-performed method for customer assistance using artificial intelligence (AI)-generated smart indicators. The method includes receiving a request for customer assistance from a user through a dynamic chatbot implemented on a chatbot server. The method includes determining user intent and context information based on the received request for customer assistance. The method includes mapping the user intent and context information, as contextual data, relative to a plurality of indicators that are suitable for display in a user interface. The method includes setting up, by an AI-based configurator, for display at least one relevant smart indicator, from the plurality of indicators, based on the mapped contextual data. The method includes generating for display, a user interface featuring the at least one relevant smart indicator, to provide customer assistance based on the AI-based configurator set up at least one relevant smart indicator.

Some embodiments include a tangible, non-transitory, computer-readable media having instructions thereupon which, when executed by a processor, cause the processor to perform a method. The method includes receiving a request for customer assistance from a user through a dynamic chatbot implemented on a chatbot server. The method includes determining user intent and context information based on the received request for customer assistance. The method includes mapping the user intent and context information, as contextual data, relative to a plurality of indicators that are suitable for display in a user interface. The method includes setting up, by an AI-based configurator, for display at least one relevant smart indicator, from the plurality of indicators, based on the mapped contextual data. The method includes generating for display, a user interface featuring the at least one relevant smart indicator, to provide customer assistance based on the AI-based configurator set up at least one relevant smart indicator.

Some embodiments include a computer-based chatbot server for customer assistance using artificial intelligence (AI)-generated smart indicators. The computer-based chatbot server includes a database and one or more computer-operable modules. The one or more computer-operable modules are to receive a request for customer assistance from a user through a dynamic chatbot implemented on the chatbot server. The one or more computer-operable modules are to determine user intent and context information based on the received request for customer assistance. The one or more computer-operable modules are to map the user intent and context information, as contextual data, relative to a plurality of indicators that are suitable for display in a user interface. The one or more computer-operable modules are to set up, by an AI-based configurator implemented on the chatbot server, for display at least one relevant smart indicator, from the plurality of indicators, based on the mapped contextual data. The one or more computer-operable modules are to generate for display, a user interface featuring the at least one relevant smart indicator, to provide customer assistance based on the AI-based configurator set up at least one relevant smart indicator.

Other aspects and advantages of the embodiments will become apparent from the following detailed description taken in conjunction with the accompanying drawings which illustrate, by way of example, the principles of the described embodiments.

### BRIEF DESCRIPTION OF THE DRA WINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

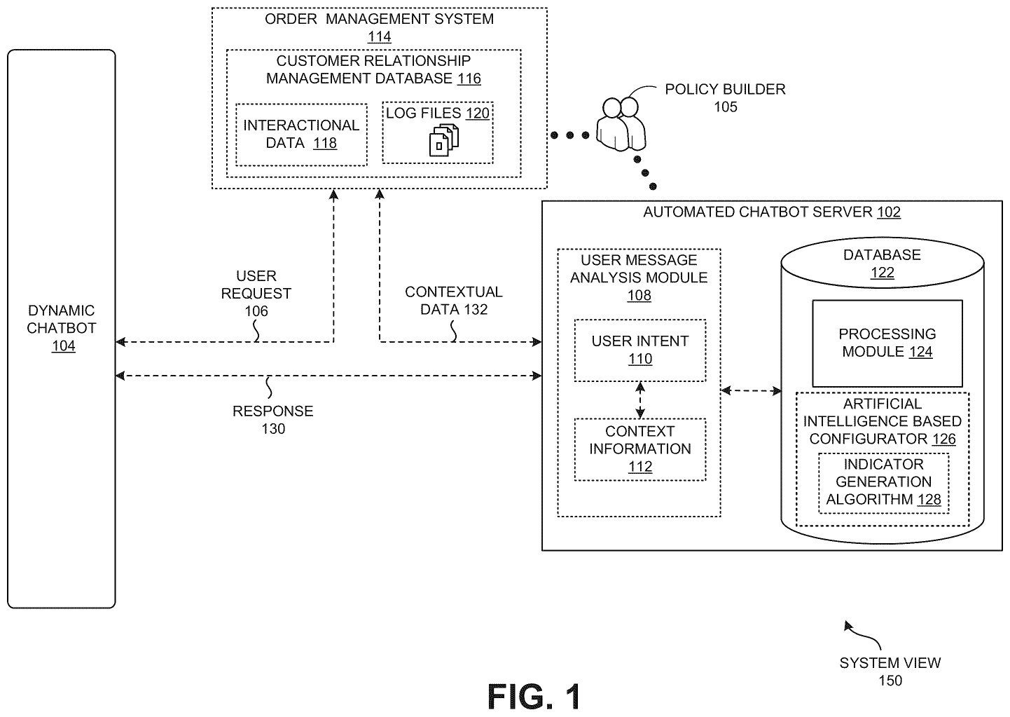

FIG. 1 is a system view of an automated chatbot application illustrating generation of an intuitive computerized response to a user's request based on context analysis of the user's interactional data through an automated chatbot server, according to some embodiments.

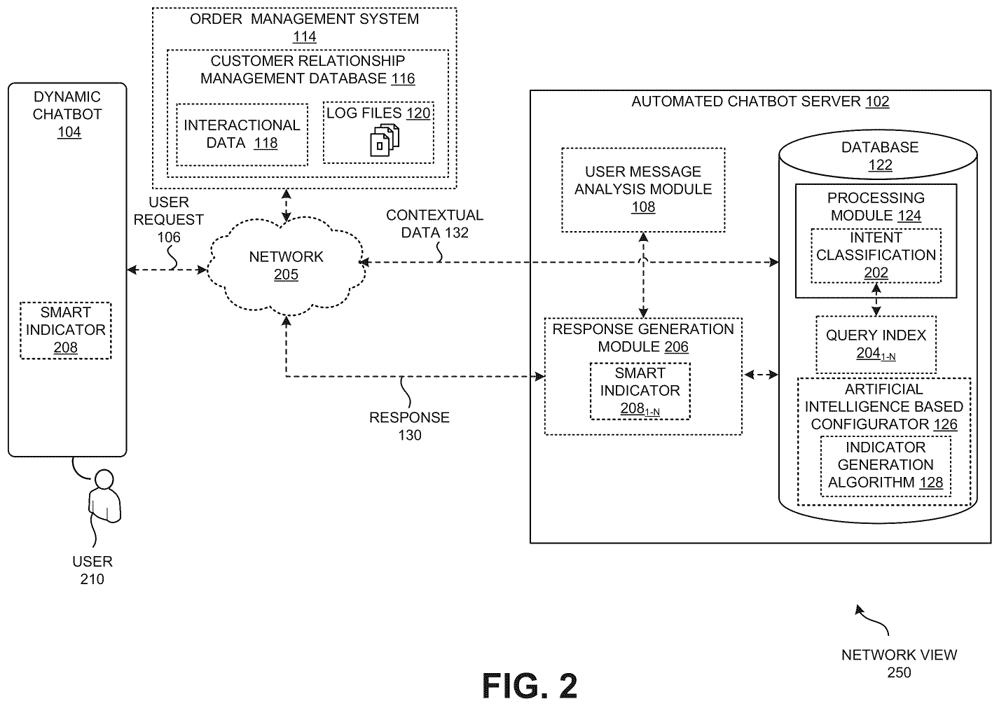

FIG. 2 is a network view of the automated chatbot server of FIG. 1 illustrating generation of a smart indicator based on interactional data and mapping of context analysis to a query index to efficiently resolve user's requests through the network, according to some embodiments.

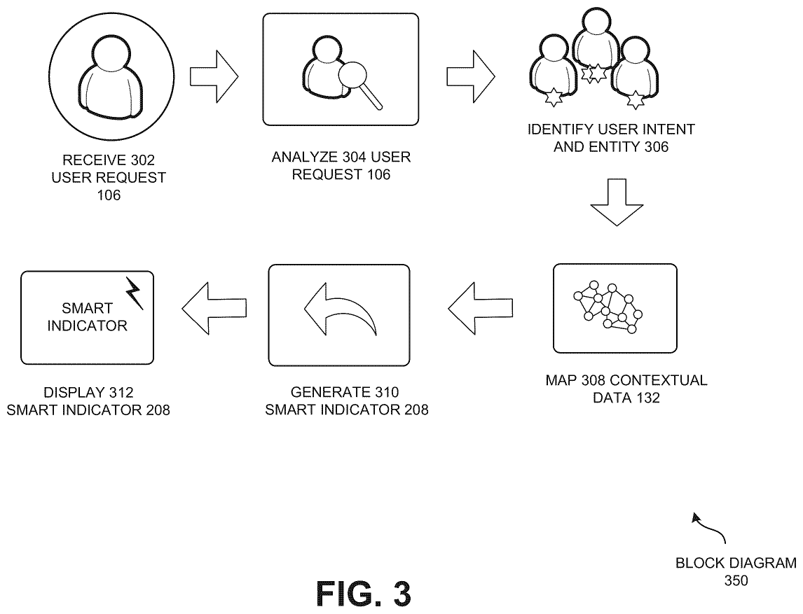

FIG. 3 is a schematic block diagram illustrating an exemplary smart indicator generation scenario of the automated chatbot application of FIG. 1, according to some embodiments.

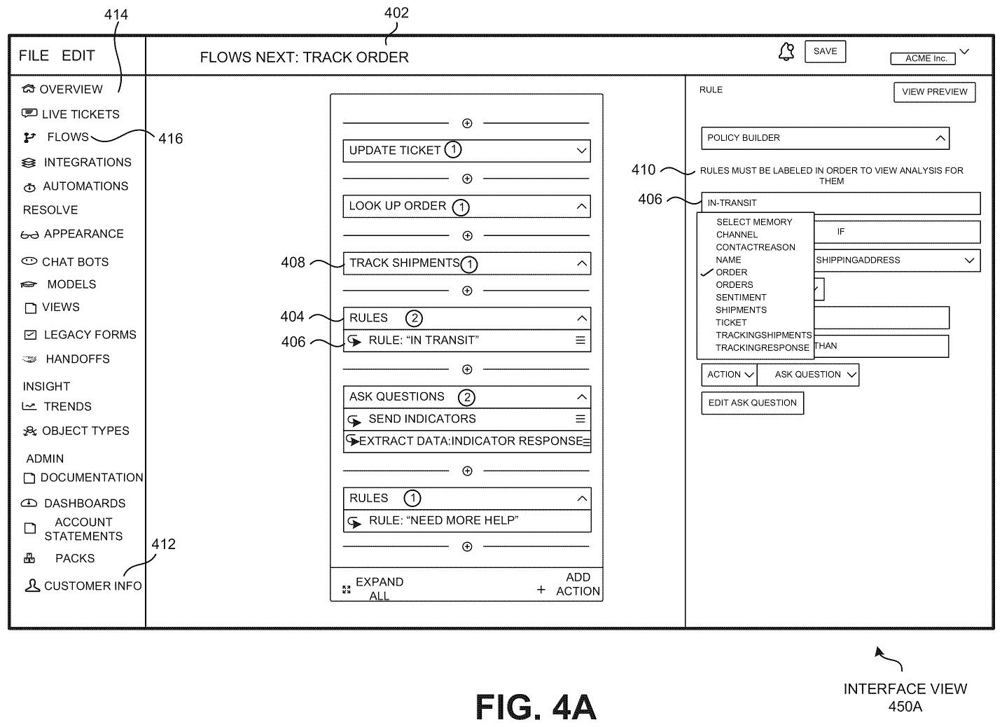

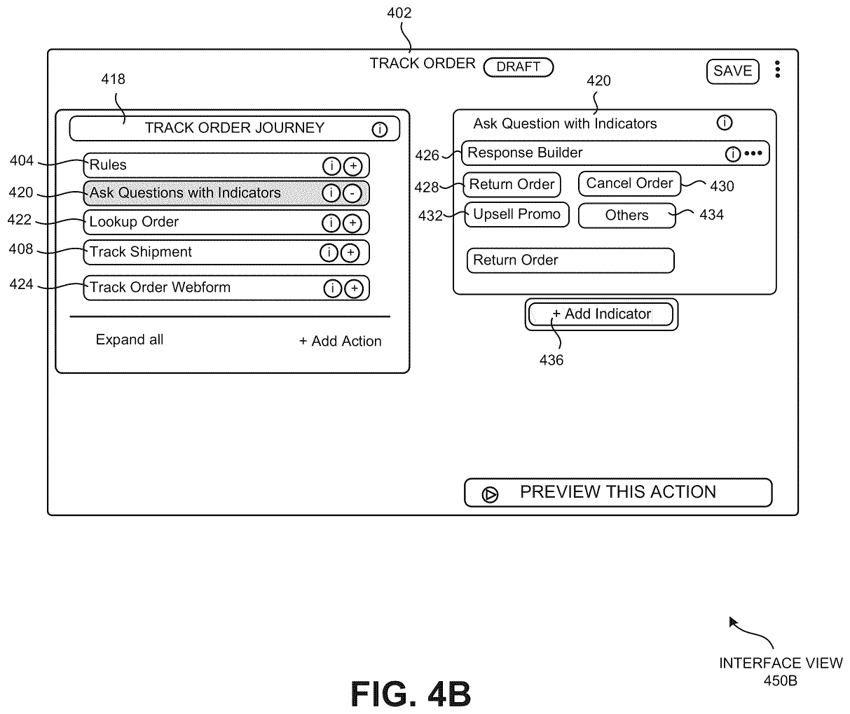

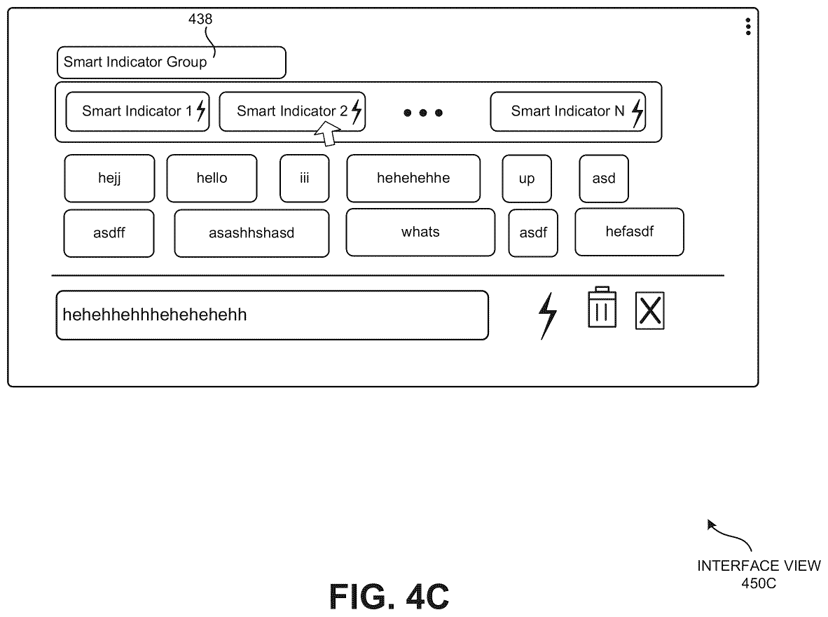

FIG. 4A is a user interface view illustrating an exemplary use-case scenario of the automated chatbot application of FIG. 1, according to some embodiments.

FIG. 4B is another user interface view illustrating an exemplary use-case scenario of the automated chatbot application of FIG. 1, according to some embodiments.

FIG. 4C is another user interface view illustrating an exemplary use-case scenario of the automated chatbot application of FIG. 1, according to some embodiments.

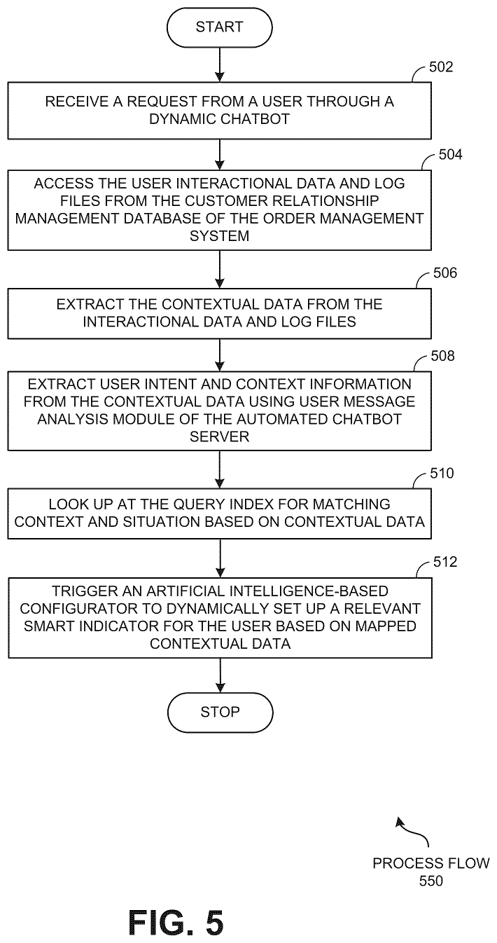

FIG. 5 is a process flow detailing the operations involved in setting up of a smart indicator onto the dynamic chatbot of FIG. 1 based on mapped contextual data, according to some embodiments.

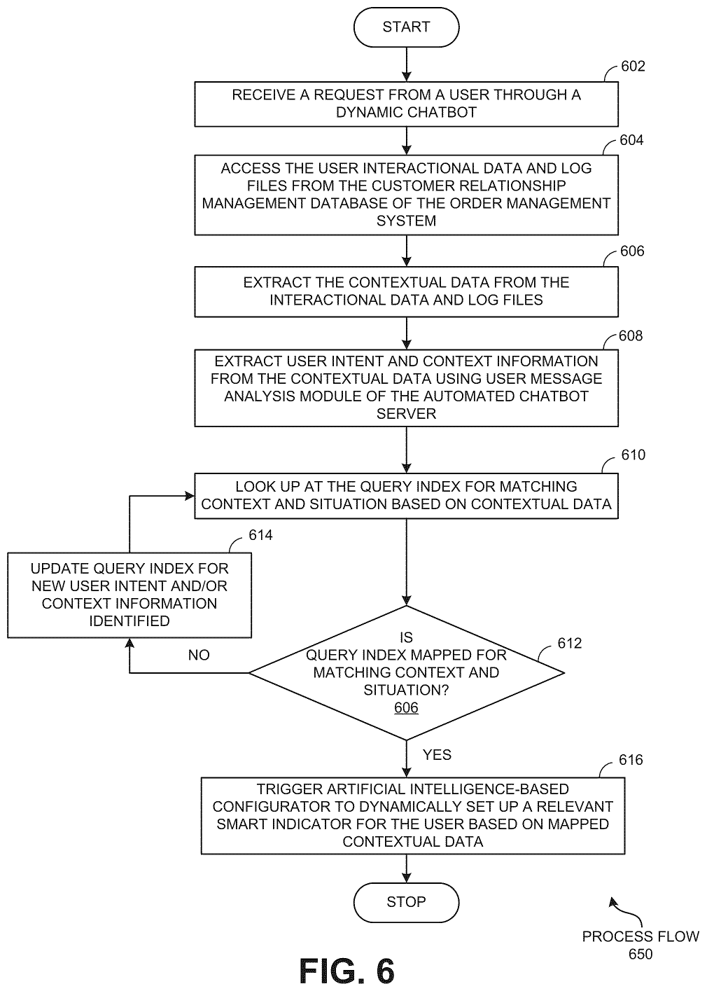

FIG. 6 is another process flow detailing the operations involved in automatically generating a smart indicator for a user of FIG. 1 when the query index is not mapped for matching context and situation based on contextual data, according to some embodiments.

### DETAILED DESCRIPTION

An enterprise may provide a platform to offer their services and/or market their products based on customer needs. A few examples of enterprise may include sectors such as beauty, apparel, electronic goods, subscription-based companies, etc. The enterprise may offer a helpdesk for its customers to interact with their system to receive information about the service and/or product offered. The helpdesk interactions may assist the enterprises understand what their customer needs in order to deliver their requests efficiently. However, the enterprise may face lack of customer satisfaction due to delayed response to customer requests and/or ineffectiveness in resolving time sensitive issues caused by deferred response. The examples of customer requests may include tracking order, exchange, return, cancel order, cancel subscription, etc. A potential customer may deflect to another service provider in the absence of appropriate and/or timely response to the customer's request leading to loss of business and/or customer dissatisfaction.

Disclosed are a method and/or a system for generating a smart indicator recommendation to configurably embed onto a dynamic chatbot (or website/app/form/virtual assistant/in-store tablets) for real-time assistance to a user based on its interactional data.

In some embodiments, the disclosed system includes an auto-indicator configuration program that may natively integrate with an existing conversational software application of an enterprise to automatically generate a smart indicator based on a customer's (e.g., user) interaction and disposition with the system through its conversational software application. The conversational software application may be a helpdesk chatbot. The auto-indicator configuration program may use customer and order identifiers and its historical data within any API-based enterprise system, such as order management systems (OMS), to dynamically generate a relevant smart indicator for the customer during an interactional event in realtime for an improved user experience. For example, various embodiments may pull customer and order data from many systems beyond OMS such as helpdesks, shipping platforms, return services, subscription platforms, and/or Customer Relationship Management (“CRM”) systems.

In alternative embodiments, the various solutions could be applied to booking systems, reservation systems, point of purchase systems, and other systems that contain but are not limited to customer and order information.

The auto-indicator configuration program may use an artificial intelligence based configurator to dynamically generate the most relevant smart indicator for the customer. The disclosed system may use artificial intelligence (AI) and natural language processing (NLP) to understand customer questions and automatically generate a set of most relevant indicators that would help achieve an optimally intuitive response to the customer's request based on customer's circumstances and/or behavior. Further, the disclosed auto-indicator configuration program integrated with the conversational software application may automatically change the selection and/or order of indicator-based options within the chatbot.

The disclosed system may combine different subsystems of the existing order management system to make all the data from customer interaction readily available for the auto-indicator configuration program to be quickly trained through deep learning methods to dynamically generate the smart indicators within the chatbot. The dynamically generated smart indicators may lead to a successful outcome in resolving the customer's problem. The auto-indicator configuration program integrated within the conversational software application and the order management system may quickly and easily utilize and/or share data to predict what the customer is looking for and present with a set of most relevant indicators.

The artificial intelligence based configurator of the disclosed system integrated within the conversational software application may include an intelligent indicator generation algorithm that may automatically change the selection and/or the order of button-based options within the chatbot. The system may explicitly provide recommendations to predict the most likely indicator options that will lead to satisfactory response to a customer's concerns and a successful outcome for the customer. The indicator generation algorithm of the disclosed system may use knowledge of the customer's disposition via integration with enterprise systems (e.g., OMS/CROM/data centers) and apply machine learning methods to the historical data and/or customer interactions to initiate a dynamic smart indicator generation. The indicator generation algorithm of the disclosed system may predict the most likely context-based indicator options that will lead to a successful outcome for the customer.

In some embodiments, the indicator generation algorithm of the disclosed system may be based on a business rule that may trigger a button set (e.g., indicator set) to appear onto the dynamic chatbot. The business rule may be based on certain scenarios that will trigger a particular smart indicator. The system may predefine a series of rules to identify the context and/or intent of a question. The system may use machine learning methods to understand the context and/or intent of a question before formulating a response.

The disclosed system may include a process to automatically change the selection and/or the order of indicator-based options within the chatbot. The indicator generation algorithm of the disclosed system may create and trigger options of smart indicators based on number of clicks counted across other users (e.g., interacting with the particular enterprise and/or a wider group), past history of a particular user (e.g., page he/she is on, past order history, whether he/she has clicked on the “Track” button before, etc.), last clicked, machine learning recommendations such as from similar users with similar sentiment of message (e.g., using collaborative filtering or deep learning), external sources such as an API or database, user experience research methodology (e.g., A/B tests), predict what they're most likely trying to do based on any of the above factors and prioritize, reorder, and/or otherwise highlight choices (e.g., smart indicator) based on the interactional data.

The disclosed system may dynamically present the choices of the set of most relevant indicators that are likely to be useful to the customer at the particular moment in the customer journey (e.g., saving the user time and effort). The disclosed system may determine the relevant smart indicators to be displayed for the particular customer based on various criteria, such as customer contact reason, customer sentiment, previous customer behaviors, word recognition, options explicitly written by other customers, by looking up at the log files of the customer's prior journeys, common agent responses, and/or any combination of the above, etc.

The disclosed system may use a neural network (or other machine learning or statistical approaches) to make smarter decisions on which smart indicators to be displayed in the limited real estate in a chat scenario to improve the customer journey and customer satisfaction scores (e.g., NPS, CSAT, customer satisfaction scores, etc.) The disclosed system may automatically hide the less likely options. The presentation of these smart options can either be chat buttons (e.g., indicators) and/or text-based choices.

The disclosed system may work within any chatbot, SMS, and/or in-app channel, etc. In SMS, the process may offer text-based choices. The disclosed system may be designed to simulate a conversation with a customer through artificial intelligence, who may interact with users by text and/or email, etc. The chatbot may scan for indicator-words (e.g., key phrases, information) within a message filled by a customer and/or apply natural language processing on the message, and provide a response with the most matching indicator-words (e.g. key phrases, information) and/or the most similar wording pattern to the customer. Search may be implemented through Term frequency/Inverse document frequency as a method of ranking search results, word vector similarity or other approaches.

In some embodiments, the disclosed system may dynamically generate smart indicators based on a collection of data collected from the enterprise system (e.g., an order management system), machine learning, counting clicks, and what people have done in the past in similar situations, etc. The disclosed system may configure an ability to provide a better selection of the smart indicator that is more likely to achieve a faster, more intuitive response for the customer.

The artificial intelligence based configurator of the disclosed system may predict what type of smart indicators a customer might need help with based on customer information available in the database once the customer interacts using the chatbot. The disclosed system may extract associated customer information such as email address, phone number, kind of staging of that customer, deals phase, and/or an active client, etc. to help the customer.

In some embodiments, the artificial intelligence based configurator of the disclosed system may allow the system to create and/or modify a workflow. For example, there may be a track order flow in the disclosed system. The intelligent indicator generation algorithm of the conversational software application may allow the user to take action in internal and/or external business systems such as an order management system.

Once a customer using the conversational software application enquires about his/her order in the “track shipment”, the conversational software application may look for the shipment and may have all information of customer and the shipment from its order management system. The rules configurator of the disclosed system may generate a set of smart indicators for “in transit” or “delivered” scenarios. Since the disclosed system includes an artificial intelligence based configurator, the system may be able to identify the specific use case as “in-transit” in the order management system. The indicator generation algorithm of the artificial intelligence based configurator may make it a smart indicator now based on a collection of other contexts such as number of indicator clicks and this becomes an indicator set which the system can create analytics around. The system can have a collection of analytics around the “in-transit” indicators which can suggest which indicators were clicked the most, which indicators were clicked the least, etc. For example, the FAQ indicator may be clicked a lot. Therefore, the system may organize the FAQ in the smart indicators for the customers who want to track their orders and/or have their orders enroute. The system may generate this particular “in transit” smart indicator for the customer in a chatbot. In one or more embodiments, various indicators may be reorganized as smart indicators based on the number of clicks and/or other criteria.

In yet some other embodiments, an artificial intelligence based configurator of the disclosed system may set up the smart indicators based on certain scenario (e.g., festival traffic, etc.). For example, the artificial intelligence based configurator may have a business rule that triggers a particular indicator set to appear and/or the order in which they appear. The artificial intelligence based configurator may dynamically change the order of the smart indicator(s) based on the response rate and/or the historical knowledge of the customer. For example, when the neural network activates (e.g., during festivals, sports tournaments, etc.) for a particular indicator that has the same kind of user journey, the artificial intelligence algorithm may dynamically reorder future expressions.

In some embodiments, a server-implemented framework is disclosed which automates the discovery and negotiation of product and service sales online and offline based on buyer- and seller-defined parameters and elasticity thresholds. Artificial intelligence (AI) negotiation agents operate on behalf of the buyers and sellers to recommend potential options, automatically and anonymously negotiate towards the best satisfaction and outcome for their respective users based on the parameters set by the users to be important and also based on market conditions. The AI negotiation agents join a multi-stage negotiation session until sufficiently improved recommendations are obtained for particular products and/or services. These negotiated, improved, offers are then transmitted to the buyers and sellers for acceptance. The AI agent for sellers optimizes sales strategy and effectiveness while the AI agent for buyers improves purchasing decision-making to enable better outcomes (financial, customer satisfaction, experience, etc.) with minimal effort.

The examples disclosed herein generally relate to an AI-powered framework whereby autonomous AI agents recommend outcomes using smart indicators (e.g., buttons, keys, action items, call to action links) deals on behalf of buyers and sellers. The buyers and sellers may communicate using the disclosed framework in an optimized way that allows various aspects of decisions (e.g., purchasing decisions) to be negotiated and adjusted nearly instantly. In some examples, the consumers use their client devices (e.g., laptop, smart phone, tablet, etc.) to anonymously organize and set up automated, on-going recommendation plans executed by multi-criteria decision-making negotiation agents on a server, referred to herein as “buyer AI negotiators” (“AI buyers,” “AI buyer agent,” “consumer bot,” or “purchasing bot” for short), for purchasing particular products or services, either online or through physical kiosks or storefronts. The various manifestations may be embodied into physical indicators at hardware. At the same time, some examples allow retailers to set up automated, on-going recommendation terminals or selling campaigns executed by multi-criteria decision-making negotiation agents on a server, referred to herein as “seller AI negotiators” (or “AI sellers” “AI seller agent” for short), that offer the seller's products or services and automatically recommendation with the buyer AI negotiators. The various embodiments may operate by combining large data sets of customer and consumer data from internal and/or external sources within an organization and applying intelligent, iterative processing algorithms to learn from patterns and features in the data that they analyze. The various embodiments may apply any one or more of the following:

Machine Learning—A specific application of AI in the embodiments described herein lets kiosks, point of purchase, and chatbots embodying the smart indicators generated through technologies described herein learn automatically and develop better results based on experience, all without being programmed to do so. These technologies permit the AI described herein to find patterns in data, uncover insights, and improve the recommendations of whatever task the system has been set out to achieve.

Deep Learning—A specific type of machine learning in the embodiments described herein allows AI to learn and improve by processing data. Deep Learning uses artificial neural networks which mimic biological neural networks in the human brain to process information, find connections between the data, and come up with inferences, or results based on positive and negative reinforcement.

Neural Networks in the embodiments described herein may be a process that analyzes data sets over and over again to find associations and interpret meaning from undefined data. Neural Networks in the embodiments described herein may operate like networks of neurons in the human brain, allowing AI systems to take in large data sets, uncover patterns amongst the data, and answer questions about it.

Cognitive Computing in the embodiments described herein may be another important component of AI systems designed to imitate the interactions between humans and machines, allowing computer models to mimic the way that a human brain works when performing a complex task, like analyzing text, speech, or images.

Natural Language Processing in the embodiments described herein may be a critical piece of the AI process in the various embodiments by permitting servers and hardware computers to recognize, analyze, interpret, and truly understand human language, either written or spoken. Natural Language Processing is critical in the embodiments described herein through an AI-driven system that interacts with humans in some way, either via text or spoken inputs.

Computer Vision in the embodiments described herein may enable the ability to review and interpret the content of an image via pattern recognition and deep learning to power the smart indicators. Computer Vision in the various embodiments may identify components of visual data, like the captchas you'll find all over the web which learn by asking customers to help them identify scenarios, choices, and navigate complexity, etc.

In some embodiments, the system integrates with a Large Language Model (LLM) to solve part or all of an issue. For example, the automated system can ask for an email, then as a step in the process, pass the email to the LLM to cancel an order. The LLM can optionally pass back control and/or data to the system when it completes its task or is unable to complete the task. For instance, the LLM can pass information about whether the order could be successfully canceled to the system or agent that triggered it to run.

In some embodiments, the system interacts with humans before, during and after its own interactions with a customer. As examples for all three scenarios:

Before: It may collect information, then pass that information to a person to complete or review the transaction.

During: It may also continue to assist the person after the point of transfer/handoff, such as continually suggesting responses to the customer service agent to send to the customer, or preventing an agent from sending a question to the customer which had already been collected by the automated system.

After: It may expose a button/method of input to a customer service agent to trigger it to run for a particular purpose, such as “Confirm this user's order information” or “cancel the order.”

The embodiments are illustrated by way of example and not limitation in the figures of the accompanying drawings, in which like references indicate similar elements and in which:

FIG. 1 is a system view 150 of an automated chatbot application illustrating generation of an intuitive computerized response 130 to a user's request 106 based on context analysis of the user's interactional data 118 through an automated chatbot server 102, according to some embodiments.

Particularly, FIG. 1 illustrates an automated chatbot server 102, a dynamic chatbot 104, a user request 106, a user message analysis module 108, a user intent 110, a context information 112, an order management system 114, a customer relationship management database 116, an interactional data 118, a log files 120, a database 122, a processing module 124, a artificial intelligence based configurator 126, an indicator generation algorithm 128, a response 130, and a contextual data 132, according to some embodiments.

The automated chatbot server 102 may be a computing device and/or a software program that provides functionality for other programs (e.g., order management system 114) and/or devices integrated with a conversational software application (e.g., dynamic chatbot 104) of an enterprise to manage response 130 to a customer request 106 over a network 205. The automated chatbot server 102 may accept and/or respond to user requests 106 made over a network 205 by managing and sharing critical organization resources. The automated chatbot server 102 may be programmed to primarily execute processing of customer requests (e.g., user request 106).

The database 122 of the automated chatbot server 102 may be an organized collection of structured information that may be easily accessed, managed, and/or updated by the automated chatbot application. The database 122 may include a processing module 124 and a user message analysis module 108 that may be integrated with the dynamic chatbot 104. The processing module 124 and user message analysis module 108 of the automated chatbot server 102 may use advanced techniques such as machine learning and natural language processing to understand and respond to a user input (e.g., user request 106).

The user message analysis module 108 may be an extension to the processing module 124 of the database 124 dedicated to a specific function of evaluating and interpreting the user interaction with the automated chatbot server 102. The user message analysis module 108 may be programmed to identify the user intent 110 from an ongoing interactional event 305 and derive context information 112 from the user's input data (e.g., user request 106). The input data may include a text, a syntax, a slang, a misspelled word, and/or a query, etc. Once a user starts interacting with the automated chatbot server 102 through its dynamic chatbot 104, it may authenticate the user in its order management system 114. In addition, the automated chatbot server 102 may extract user identification data and corresponding interactional data 118 of the authenticated user 210 from its order management system 114. The order management system 114 may store each authenticated user's interactional data 118 and create log files 120 of each of its user communication. During interaction, the processing module 124 may map the previous interactional data 118 with the user intent 110 and the derived context information 112. Based on its real-time mapping of context information 112, the response generation module 206 may look up at the query index 204 for matching context and/or situation, thereby automatically presenting with a smart indicator 208 found for similar context and situation.

In another embodiment, when the response generation module 206 is unable to map the extracted context information 112 onto the query index 204, it may trigger the artificial intelligence based configurator 126 to dynamically generate a relevant set of indicators (e.g., smart indicator 208) based on the extracted context information 112 and user intent 110 identified. The artificial intelligence based configurator 126 may use indicator generation algorithm 128 to set up and/or generate a most relevant set of indicators (e.g., smart indicator 208_{1-N}) for the user based on the context information 112, user intent 110, and customer relational data derived from interactional data 118 and log files 120. Further, the response generation module 206 may concurrently update the query index 204 each time the user intent 110 and/or derived context information 112 do not map with existing query index 204 to include the newly identified user intent 110 and/or context information 112. Subsequently, the response generation module 206 may present with the newly generated smart indicator 208 in realtime when a similar context and/or situation is identified in the future.

The database 122 of the automated chatbot server 102 may automatically maintain semantic data by structuring the interactional data 118 and context information 112 derived from the user intent 110 in order to represent it in a specific logical way each time a user interacts through the dynamic chatbot 104. The semantic data may help identify the set of conditions that will trigger the artificial intelligence based configurator 126 to automatically generate and/or display a relevant set of indicators (e.g., smart indicator 208) for the user 210.

The query index 204 of the database 122 of automated chatbot server 102 may be special lookup tables for queries requesting information that the database search engine can use to speed up data retrieval. The query index 204 may be a pointer to data in a table. The query index 204 of the database 122 may include a series of defined rules 404 identified for different scenarios based on the workflow process. The processing module 124 may be trained to map out the conversations onto the defined business rules 404 for different scenarios and can deliver solutions accordingly.

The policy builder 105 may identify the different scenarios based on the workflow process (e.g., workflow 416) to define the business rules 404. The policy builder 105 may make a query to retrieve data and/or change information in the database 122, such as adding and/or removing data. The processing module 124 may modify and/or update a query index 204 each time a user 210 interacts with a different query describing a similar situation.

The automated chatbot server 102 may be able to dynamically generate more natural and human-like responses, and it can also adapt and improve its responses (e.g., response 130) over time using machine learning methods and artificial intelligence to train its data resources.

The dynamic chatbot 104 may be a software program that mimics a conversation with a real person (e.g., customer service executive) and/or a user via text and/or voice seeking a service and/or a request from an enterprise. The dynamic chatbot 104 may include a series of graphical and language elements that allow for human-computer interaction.

The dynamic chatbot 104 may use machine learning and natural language processing (NLP) techniques to generate more natural and human-like responses, and may adapt to the context and evolve over time. The disclosed dynamic chatbot 104 may boost engagement with a user 210 by generating automated messages, text, smart buttons (e.g., smart indicator 208), and/or images when interacting with the customers. The response generation module 206 of the automated chatbot server 102 may learn from past interactions and improve its responses 130, it may change its behavior based on the context of the conversation, it may generate new responses 130, and it may understand the intent behind the user input (e.g., user request 106).

The dynamic chatbot 104 of the automated chatbot server 102 may be built on a neural network. The dynamic chatbot 104 platform may be capable of understanding intents, interpreting dialogues, and/or supporting multiple languages, etc. Other capabilities that the dynamic chatbot 104 may include-graphical UI, drag and drop interface, easy integration into workflows flow 416, API communication, scalable automated customer service, multilingual database, 24/7 access, user analytics, sentiment analysis, monitoring and/or tracking capabilities, etc.

The smart indicators 208 of the dynamic chatbot 104 may help with a typeless experience and increase customer engagement with quick navigation. The dynamic chatbot 104 may also facilitate cards and carousels, which ensure better customer attention, with suggestions that help the customer (e.g., user 210) take prompt action.

For example, the dynamic chatbot 104 may help a first time user 210 to understand the complexities of the website, and automatically embed a relevant smart indicator 208 to encourage the user 210 and guide him into asking a question by highlighting different navigation options. The response generation module 206 of the automated chatbot server 102 may automatically adapt the dynamic chatbot 104 according to user's input to generate and/or output the most relevant smart indicator 208 and encourage the user 210 to register their response. The dynamic chatbot 104 may register the user's satisfaction, adapt it's models 405 accordingly, and begin a new interaction with another user.

The dynamic chatbot 104 may adapt and inspire a user. The smart indicator 208 of the dynamic chatbot 104 may make the chatbot easy to interact with, convenient, and have a human connection. The dynamic chatbot 104 may be configured to engage customers more, solve their issues, collect information, and as a way to interact with the enterprises.

The processing module 108 of the automated chatbot server 102 may be programmed to take action based on what a user 210 says as well as given personalities, their behavior and personas. The AI-based response generation module 206 and the artificial intelligence based configurator 126 of the automated chatbot server 102 integrated with the dynamic chatbot 104 may be trained to consider slang, intonation, humor, syntax, context, and misspellings and/or a possible scenario that is nuanced.

In another embodiment, the dynamic chatbot 104 platform may be a framework with all the coding and engines architectured into it to generate a smart indicator 208 based on the user intent 110 recognition and context information 112 derived from the user request 106. The smart indicator 208 integrated within the dynamic chatbot 104 may function as an extension of a brand that may be designed to provide engaging and novel conversational experiences by providing a quick response 130.

The smart indicator 208 of the dynamic chatbot 104 may be designed to facilitate effective interaction between the user 210 and the automated chatbot server 102 navigated via its webpage (e.g., a software application, API, etc.) and/or machine through an effective design and responsiveness. The user request 106 may be a formal way of asking for something from an enterprise offering a service through an interactional dynamic chatbot 104.

The user message analysis module 108 may map a sentence and/or a set of input data of an ongoing interactional event 305 into an intent (e.g., user intent 110) to find out an intent classification 202. With every intent, there may be an associated set of responses and corresponding smart indicator 208_{1-N}. The user message analysis module 108 and processing module 124 may pick up one of these responses 130 and corresponding smart indicator 208_{1-N} matching the user intent 110, and send it back to the user 210 to be displayed on the dynamic chatbot 104. The user message analysis module 108 may use artificial intelligence to identify user's intent 110 to interact with the UI. The automated chatbot server 102 may take a look at the words and possibly their arrangement in order to figure out what the intent (e.g., user intent 110) is. This can be done in multiple ways such as simple word mapping and/or machine learning methods. For example, words like hi, hello, what's, etc. may be mapped to the greeting intent in the query index 204_{1-N} along with its intent classification 202.

In another example embodiment, the system may use Machine Learning methods to easily identify a problem and/or user intent 110 under a supervised learning based on intent classification 202 and/or context information 112. The disclosed system may include a collection of sentences and the corresponding intent against them stored in the query index 204_{1-N}. Whenever a user comes up with a new sentence, the system may need to classify it as belonging to one of the intents in the intent classification 202. The system may train the algorithm to convert the sentence into a vector of numbers to automatically update the query index 204. The corresponding intents may also be given ‘codes’ to identify them numerically. This input may be fed to a training algorithm which learns how to classify these sentences in the query index 204. Later on, the trained query index 204 model (e.g., model 405) may be used to classify new sentences in the intent classification 202. Over time, it can be retrained with fresh data so as to make it learn better in order to automatically generate a most relevant smart indicator 208 to be displayed on the dynamic chatbot 104 for the user 210. Once the intent has been identified based on mapped context information 112 onto the query index 204, the automated chatbot server 102 may pick up one of the response 130 and/or smart indicator 208 corresponding to the mapped intent.

The customer relationship management database 116 of the system may be an organized collection of structured information of its users visiting the website and corresponding interactional data 118 for each session that may be easily accessed, managed, and updated by the system. In addition, the customer relationship management database 116 may maintain a log file 120 of each user interaction (e.g., interactional data 118) and/or session.

FIG. 2 is a network view 250 of the automated chatbot server 102 of FIG. 1 illustrating generation of a smart indicator 208 based on interactional data 118 and mapping of context analysis to a query index 204 to efficiently resolve user's requests through the network 205, according to some embodiments. Particularly FIG. 2 builds on FIG. 1, and further adds, an intent classification 202, a query index 204, a response generation module 208, a user 210, and a network 205, according to some embodiments.

The intent classification 202 may be a process of organizing the customer's intent (e.g., request 106) by analyzing the language they use. The intent classification 202 may help the system to recognize the purpose and/or objective of the user 210 using the webpage and/or API. The system may use machine learning and natural language processing to associate text data and expression to a given intent in the intent classification 202. In other words, intent recognition May take a given query as an input and associate it to the target class in the intent classification 202 to help generate a smart indicator 208, according to some embodiments.

As described in various embodiments of FIG. 1, the automated chatbot server 102 may receive a request 106 from a user 210. The processing module 124 of the automated chatbot server 102 may derive contextual data 132 based on user's disposition via integration with its order management system 114. The processing module 124 may map the contextual data 132 onto the query index 204 to identify a similar context and/or situation. Once mapped, the processing module 124 may predict the most likely button options that will lead to successful outcome by displaying the relevant smart indicator 208 onto the user's dynamic chatbot 104. Alternatively, when the contextual data 132 is not mapped, the response generation module 206 may trigger the artificial intelligence based configurator 126 to dynamically generate a relevant set of indicators (e.g., smart indicator 208) based on the extracted context information 112 and user intent 110 identified.

FIG. 3 is a schematic block diagram 350 illustrating an exemplary smart indicator generation scenario of the automated chatbot application of FIG. 1, according to some embodiments.

According to some embodiments, a user may start an interactional event 305 with the automated chatbot server 102 through its dynamic chatbot 104. The automated chatbot server 102 may receive 302 a user request 106 through this interactional event 305. The automated chatbot server 102 may use natural language processing and machine learning methods to analyze 304 the user request 106. The user message analysis module 108 of the automated chatbot server 102 may identify the user intent 110 and entity 306 from the ongoing interactional event 305 and user request 106. The processing module 124 of the automated chatbot server 102 may map 308 the contextual data 132 with the user intent 110 and the derived context information 112. Based on its realtime mapping of context information 112, the response generation module 206 may look up at the query index 204 for matching context and/or situation. Once mapped, the response generation module 206 may present a smart indicator 208 found for similar context and situation. Alternatively, the response generation module 206 may trigger the artificial intelligence based configurator 126 to dynamically generate 310 a relevant set of indicators when the query index 204 is not mapped for matching context and/or situation. Subsequently, the automated chatbot server 102 may display 312 the most relevant smart indicator 208 onto the dynamic chatbot 104 for the user 210, according to some embodiments.

FIG. 4A is a user interface view 450A illustrating an exemplary use-case scenario of the automated chatbot application of FIG. 1, according to some embodiments.

In one or more embodiments, the user interface view 450A illustrates an internal focused helpdesk for a policy builder 105. As shown in the figure, the policy builder 105 may be authorized to build and/or modify the workflow (e.g., flows 416) for a particular enterprise by creating rules 404 for each workflow. The policy builder 105 may use the interface to monitor, build, and/or modify its various workflow processes (e.g., flows 416) such as track orders 402, cancel orders, etc. to assist its customers.

The interface shows a decision tree builder 414 for a policy builder 105 with number of connected charts and/or connected branches that allows the policy builder 105 to create rules 404 for a number of process flows 416. In some embodiments, the decision tree builder may be a product which hides the complexity of decision trees in an easy-to-use interface to govern logic, policy and response building.

For example, there may be a “track order” 402 workflow. The first step may be to take up the tags. The policy builder 105 may look up the order connected to the Order Management System (OMS). Based on the order number connected to the OMS, the policy builder 105 may have all the information about the customer (e.g., customer info 412) and the shipments. The policy builder 105 may track shipments 408 and create rules 404 for the particular workflow process. The policy builder 105 may label the rule “In-Transit” 406 in order to view the analytics for them and identify it. The policy builder 105 may now create buttons (e.g., smart indicator group 438) that are specific to this particular use case. For example, once the rules 404 are defined by the policy builder 105, he/she may be able to receive a collection of analytics around the “In-Transit” 406 indicators (e.g., smart indicator 208). The disclosed system may build analytics based on a number of variables such as which indicators (e.g., smart indicator 208) were clicked the most, which indicators were clicked the least, timestamp, screen time, trends, social events, etc. of the customers visiting the automated chatbot application webpage. Based on the real-time analytics, the smart indicators section for “In-Transit” 406 may be organized. If the number of clicks aggravates such that people having the specific indicators start clicking on that same kind of user journey, that indicators get the most clicks and may automatically reorders and move its position up in order, according to some embodiments.

One or more embodiments may provide an add-on for a customer of the automated chatbot application in the form of a smart indicator 208 based on what information the customer is looking for. The smart indicator 208 may automatically generate, recommend, suggest, and/or display a set of options related to the customer's context to help the customer (e.g., user 210) easily navigate and interact with the system by effectively providing a quick response 130, according to some embodiments.

FIG. 4B is another user interface view 450B illustrating an exemplary use-case scenario of the automated chatbot application of FIG. 1, according to some embodiments. The exemplary user interface illustrates a number of tabs for the policy maker 105 to set up policy rules 404 for its number of workflows 416. For example, the track order journey 418 may show a number of tabs, such as rules 404 tab, “Ask Questions with Indicators” 420 tab, “Lookup Order” 422 tab, “Track Shipment” 408 tab, and “Track Order Webform” 424 tab. Once the policy builder 105 selects the “Ask Questions with Indicators” 420 tab, the interface provides a number of options to build a set of indicators. The “Response Builder” 426 tab of the “Ask Questions with Indicators” 420 interface may allow creating smart indicators 208 to respond to various workflows such as Return Order 428, Cancel Order 430, Upsell Promo 432, and Others 434, etc. The “Response Builder” 426 tab may help add respective indicator for the particular workflow using the “Add Indicators” 436 tab, according to some embodiments.

FIG. 4C is another user interface view 450C illustrating an exemplary use-case scenario of the automated chatbot application of FIG. 1, according to some embodiments.

The interface illustrates a smart indicator group 438 created for a particular use case. The policy builder 105 may send a smart indicator 208 for a customer (e.g., user 210) by selecting a smart indicator 208 from the smart indicator group 438 matching the customer's context and identified scenario, according to some embodiments.

FIG. 5 is a process flow 550 detailing the operations involved in setting up of a smart indicator 208 onto the dynamic chatbot 104 of FIG. 1 based on mapped contextual data 132, according to some embodiments.

In operation 502, the automated chatbot server 102 may receive a request 106 from a user 210 through a dynamic chatbot 104. In operation 504, the automated chatbot server 102 may access the user interactional data 118 and log files 120 from the customer relationship management database 116 of the order management system 114. In operation 506, the automated chatbot server 102 may extract the contextual data 132 from the interactional data 118, log files 120, and user request 106, according to some embodiments.

In operation 508, the user message analysis module 108 of the automated chatbot server 102 may map user intent 110 and context information 112 from the contextual data 132 onto the query index 204 using user message analysis module 108 of the automated chatbot server 102, according to some embodiments.

In operation 510, the processing module 124 may look up at the query index 204 for matching context and situation based on contextual data 132. In operation 512, the processing module 124 may trigger the artificial intelligence based configurator 126 to dynamically set up a relevant smart indicator 208 for the user 210 based on mapped contextual data 132, according to some embodiments.

FIG. 6 is another process flow 650 detailing the operations involved in automatically generating a smart indicator 208 for a user 210 of FIG. 1 when the query index is not mapped for matching context and situation based on contextual data 132, according to some embodiments. In operation 602, the automated chatbot server 102 may receive a request 106 from a user 210 through a dynamic chatbot 104.

In operation 604, the automated chatbot server 102 may access the user interactional data 118 and log files 120 from the customer relationship management database 116 of the order management system 114. In operation 606, the automated chatbot server 102 may extract the contextual data 132 from the interactional data 118, log files 120, and user request 106, according to some embodiments.

In operation 608, the user message analysis module 108 of the automated chatbot server 102 may map user intent 110 and context information 112 from the contextual data 132 onto the query index 204 using user message analysis module 108 of the automated chatbot server 102.

In operation 610, the processing module 124 may look up at the query index 204 for matching context and situation based on contextual data 132. In operation 612, the processing module 124 may check whether the query index 204 is mapped for matching context and situation based on contextual data 132. In operation 614, if the query index 204 is not mapped for the identified context and situation, the processing module 124 may update the query index 204 for the newly identified intent and/or context information.

If the query index 204 is mapped, the processing module 124 may trigger the artificial intelligence based configurator 126 to dynamically set up a relevant smart indicator 208 for the user 210 based on mapped contextual data 132 in operation 616, according to some embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A computer-performed method for customer assistance using artificial intelligence (AI)-generated smart indicators, comprising:
receiving a request for customer assistance from a user through a dynamic chatbot implemented on a chatbot server;
determining user intent and context information based on the received request for customer assistance;
mapping the user intent and context information, as contextual data, relative to a plurality of indicators that are suitable for display in a user interface;
setting up, by an AI-based configurator, for display at least one relevant smart indicator, from the plurality of indicators, based on the mapped contextual data; and
generating for display, a user interface featuring the at least one relevant smart indicator, to provide customer assistance based on the AI-based configurator set up at least one relevant smart indicator.

2. The computer-performed method for customer assistance using AI-generated smart indicators of claim 1, further comprising:
determining, for a received further request for customer assistance from the user through the dynamic chatbot, that a trained query index is not mapped for matching contextual data determined from the further request; and
updating the query index for new user intent or context information based on the contextual data determined from the further request, for use by the AI-based configurator.

3. The computer-performed method for customer assistance using AI-generated smart indicators of claim 1, wherein setting up, by an AI-based configurator, for display at least one relevant smart indicator, from the plurality of indicators, based on the mapped contextual data comprises the AI-based configurator performing at least one from a group of actions consisting of:
applying machine learning methods to historical data or customer interactions to initiate dynamic smart indicator generation;
applying business rules to trigger a button set to appear based on context or intent of a question;
creating and triggering options of smart indicators based on number of clicks counted across other users, past history of a particular user, or machine learning from similar users with similar content of message; and
using collaborative filtering or deep learning, based on clicks or messages of users.

4. The computer-performed method for customer assistance using AI-generated smart indicators of claim 1, wherein setting up, by an AI-based configurator, for display at least one relevant smart indicator, from the plurality of indicators, based on the mapped contextual data comprises the AI-based configurator performing at least one from a group of actions consisting of:
prioritizing, reordering, or highlighting choices available to the user through at least a subset of the plurality of indicators;
dynamically presenting choices of a set of most relevant indicators; and
determining to display or hide each of the plurality of indicators.

5. The computer-performed method for customer assistance using AI-generated smart indicators of claim 1, wherein setting up, by an AI-based configurator, for display at least one relevant smart indicator, from the plurality of indicators, based on the mapped contextual data comprises the AI-based configurator performing:
organizing frequently asked questions (FAQ) in smart indicators for customers who want to track orders.

6. The computer-performed method for customer assistance using AI-generated smart indicators of claim 1, wherein setting up, by an AI-based configurator, for display at least one relevant smart indicator, from the plurality of indicators, based on the mapped contextual data comprises the AI-based configurator performing:
setting up smart indicators based on a scenario, through a business rule that triggers a particular indicator set to appear or the order in which indicators appear.

7. The computer-performed method for customer assistance using AI-generated smart indicators of claim 1, wherein setting up, by an AI-based configurator, for display at least one relevant smart indicator, from the plurality of indicators, based on the mapped contextual data comprises the AI-based configurator performing:
mapping input data of an interactional event into an intent through an intent classification having an associated set of responses and corresponding smart indicators; and
selecting one or more of the corresponding smart indicators matching user intent.

8. The computer-performed method for customer assistance using AI-generated smart indicators of claim 1, further comprising:
determining a plurality of rules for a plurality of process flows through a policy builder;
determining buttons of a smart indicator group specific to each particular use case;
building analytics, in use, on clicking of indicators; and
organizing smart indicators sections for the process flows, based on the analytics, for use by the AI-based configurator.

9. A tangible, non-transitory, computer-readable media having instructions thereupon which, when executed by a processor, cause the processor to perform a method comprising:
receiving a request for customer assistance from a user through a dynamic chatbot implemented on a chatbot server;
determining user intent and context information based on the received request for customer assistance;
mapping the user intent and context information, as contextual data, relative to a plurality of indicators that are suitable for display in a user interface;
setting up, by an AI-based configurator, for display at least one relevant smart indicator, from the plurality of indicators, based on the mapped contextual data; and
generating for display, a user interface featuring the at least one relevant smart indicator, to provide customer assistance based on the AI-based configurator set up at least one relevant smart indicator.

10. The tangible, non-transitory, computer-readable media of claim 9, wherein the method further comprises:
determining, for a received further request for customer assistance from the user through the dynamic chatbot, that a trained query index is not mapped for matching contextual data determined from the further request; and
updating the query index for new user intent or context information based on the contextual data determined from the further request, for use by the AI-based configurator.

11. The tangible, non-transitory, computer-readable media of claim 9, wherein setting up, by an AI-based configurator, for display at least one relevant smart indicator, from the plurality of indicators, based on the mapped contextual data comprises the AI-based configurator performing at least one from a group of actions consisting of:
applying machine learning methods to historical data or customer interactions to initiate dynamic smart indicator generation;
applying business rules to trigger a button set to appear based on context or intent of a question;
creating and triggering options of smart indicators based on number of clicks counted across other users, past history of a particular user, or machine learning from similar users with similar content of message; and
using collaborative filtering or deep learning, based on clicks or messages of users.

12. The tangible, non-transitory, computer-readable media of claim 9, wherein setting up, by an AI-based configurator, for display at least one relevant smart indicator, from the plurality of indicators, based on the mapped contextual data comprises the AI-based configurator performing at least one from a group of actions consisting of:
prioritizing, reordering, or highlighting choices available to the user through at least a subset of the plurality of indicators;
dynamically presenting choices of a set of most relevant indicators; and
determining to display or hide each of the plurality of indicators.

13. The tangible, non-transitory, computer-readable media of claim 9, wherein setting up, by an AI-based configurator, for display at least one relevant smart indicator, from the plurality of indicators, based on the mapped contextual data comprises the AI-based configurator performing:
organizing frequently asked questions (FAQ) in smart indicators for customers who want to track orders.

14. The tangible, non-transitory, computer-readable media of claim 9, wherein setting up, by an AI-based configurator, for display at least one relevant smart indicator, from the plurality of indicators, based on the mapped contextual data comprises the AI-based configurator performing:
setting up smart indicators based on a scenario, through a business rule that triggers a particular indicator set to appear or the order in which indicators appear.

15. The tangible, non-transitory, computer-readable media of claim 9, wherein setting up, by an AI-based configurator, for display at least one relevant smart indicator, from the plurality of indicators, based on the mapped contextual data comprises the AI-based configurator performing:
mapping input data of an interactional event into an intent through an intent classification having an associated set of responses and corresponding smart indicators; and
selecting one or more of the corresponding smart indicators matching user intent.

16. The tangible, non-transitory, computer-readable media of claim 9, wherein the method further comprises:
determining a plurality of rules for a plurality of process flows through a policy builder;
determining buttons of a smart indicator group specific to each particular use case;
building analytics, in use, on clicking of indicators; and
organizing smart indicators sections for the process flows, based on the analytics, for use by the AI-based configurator.

17. A computer-based chatbot server for customer assistance using artificial intelligence (AI)-generated smart indicators, comprising:
a database; and
one or more computer-operable modules, to:
receive a request for customer assistance from a user through a dynamic chatbot implemented on the chatbot server;
determine user intent and context information based on the received request for customer assistance;
map the user intent and context information, as contextual data, relative to a plurality of indicators that are suitable for display in a user interface;
set up, by an AI-based configurator implemented on the chatbot server, for display at least one relevant smart indicator, from the plurality of indicators, based on the mapped contextual data; and
generate for display, a user interface featuring the at least one relevant smart indicator, to provide customer assistance based on the AI-based configurator set up at least one relevant smart indicator.

18. The computer-based chatbot server for customer assistance using AI-generated smart indicators of claim 17, wherein the one or more computer-operable modules are further to:
determine, for a received further request for customer assistance from the user through the dynamic chatbot, that a trained query index is not mapped for matching contextual data determined from the further request; and
update the query index for new user intent or context information based on the contextual data determined from the further request, for use by the AI-based configurator.

19. The computer-based chatbot server for customer assistance using AI-generated smart indicators of claim 17, wherein to set up, by an AI-based configurator, for display at least one relevant smart indicator, from the plurality of indicators, based on the mapped contextual data comprises the AI-based configurator to perform at least one from a group of actions consisting of:
apply machine learning methods to historical data or customer interactions to initiate dynamic smart indicator generation;
apply business rules to trigger a button set to appear based on context or intent of a question;
create and trigger options of smart indicators based on number of clicks counted across other users, past history of a particular user, or machine learning from similar users with similar content of message; and
use collaborative filtering or deep learning, based on clicks or messages of users.

20. The computer-based chatbot server for customer assistance using AI-generated smart indicators of claim 17, wherein to set up, by an AI-based configurator, for display at least one relevant smart indicator, from the plurality of indicators, based on the mapped contextual data comprises the AI-based configurator to perform at least one from a group of actions consisting of:
prioritize, reorder, or highlight choices available to the user through at least a subset of the plurality of indicators;
dynamically present choices of a set of most relevant indicators; and
determine to display or hide each of the plurality of indicators.

21. The computer-based chatbot server for customer assistance using AI-generated smart indicators of claim 17, wherein to set up, by an AI-based configurator, for display at least one relevant smart indicator, from the plurality of indicators, based on the mapped contextual data comprises the AI-based configurator to:
organize frequently asked questions (FAQ) in smart indicators for customers who want to track orders.

22. The computer-based chatbot server for customer assistance using AI-generated smart indicators of claim 17, wherein to set up, by an AI-based configurator, for display at least one relevant smart indicator, from the plurality of indicators, based on the mapped contextual data comprises the AI-based configurator to:
set up smart indicators based on a scenario, through a business rule that triggers a particular indicator set to appear or the order in which indicators appear.

23. The computer-based chatbot server for customer assistance using AI-generated smart indicators of claim 17, wherein to set up, by an AI-based configurator, for display at least one relevant smart indicator, from the plurality of indicators, based on the mapped contextual data comprises the AI-based configurator to:
map input data of an interactional event into an intent through an intent classification having an associated set of responses and corresponding smart indicators; and
select one or more of the corresponding smart indicators matching user intent.

24. The computer-based chatbot server for customer assistance using AI-generated smart indicators of claim 17, wherein the one or more computer-operable modules are further to:
determine a plurality of rules for a plurality of process flows through a policy builder;
determine buttons of a smart indicator group specific to each particular use case;
build analytics, in use, on clicking of indicators; and
organize smart indicators sections for the process flows, based on the analytics, for use by the AI-based configurator.
